(19) United States
(12) Patent Application Publication
(10) Pub. No.: US 2011/0070841 A1
(43) Pub. Date: Mar. 24, 2011

(54) METHOD, SYSTEM, AND COMPUTER-READABLE MEDIUM FOR IMPROVED PREDICTION OF SPECTRUM OCCUPANCY AND ESTIMATION OF RADIO SIGNAL FIELD STRENGTH

(76) Inventor: Jesse Caulfield, McLean, VA (US)

(21) Appl. No.: 12/887,370

(22) Filed: Sep. 21, 2010

Related U.S. Application Data
(60) Provisional application No. 61/244,447, filed on Sep. 22, 2009.

(51) Int. Cl. H04B 17/00

(52) U.S. Cl. 455/67.11

(57) ABSTRACT

In an embodiment of the invention, a system may include a specially configured computer having at least one processor and at least one storage device. The computer may be configured to calculate an estimate of radio propagation and signal strength using a first radio propagation model. The computer may recalculate the estimate of radio propagation and signal strength using one or more additional radio propagation models. The computer may store the recalculated estimate of radio propagation and signal strength in storage.

This application claims the benefit of U.S. Provisional Application No. 61/244,447, filed Sep. 22, 2009. The above referenced application is hereby incorporated by reference in its entirety.

### BACKGROUND

1. Field of the Invention

Various aspects of the present invention generally relate to wireless communications and, more particularly, to the identification of radio signals over large geographic areas and also at specific locations.

2. Description of the Related Art

Wireless transmitters such as, but not limited to, AM/FM radio stations, television broadcast stations, mobile phones, medical telemetry devices, wireless microphones, etc. may cause undesired interference with other wireless radiators. One method of establishing interference avoidance between transmitters may be to define geographic protected contours, or exclusion zones, around primary licensed transmitters. If other unlicensed or secondary transmitters are physically located within the primary transmitter's geographic service contour, the secondary transmitter may not transmit on the primary transmitter's protected frequencies. If the secondary device is outside the contour, the frequencies may be deemed unprotected and available for wireless use.

However, protected service contours may not fully contain a transmitter's entire radio signal. This effect is more pronounced in lower frequencies such as, but not limited to, the television, AM, and FM bands, where strong usable signal can extend beyond, for example, a broadcast TV transmitter's protected geographic contour distance for many tens of miles. While the spectrum may be unprotected and considered available for operation, this residual signal energy may render the spectrum undesirable or unsuitable for other wireless use. Relying upon geographic service contours alone may not provide sufficient information for transmitters to effectively avoid interference with other wireless transmitters potentially operating at great distance. Accurate estimation of transmitter field strength across large geographic areas and also at specific receiver locations may be desired.

### SUMMARY OF THE INVENTION

In an exemplary embodiment, a computer-implemented method to calculate radio propagation and estimate radio signal strength may include calculating a first estimate of radio propagation and signal strength by a computer having at least one processor using a first radio propagation model. The computer-implemented method may also include calculating a second estimate of radio propagation and signal strength by the computer using a second radio propagation model. The computer-implemented method may also include creating a corrective estimate of radio propagation and signal strength by the computer using the first estimate and the second estimate.

In another embodiment, a system may include a computer which has at least one processor and at least one storage device. The computer may be configured to calculate an estimate of radio propagation and signal strength by using a first radio propagation model and the at least one processor. The computer may also be configured to recalculate the estimate of radio propagation and signal strength using one or more additional radio propagation models and the at least one processor. The computer may be configured to store the recalculated estimate of radio propagation and signal strength in the at least one storage device.

In yet another embodiment, a computer-readable medium may include processor executable instructions. The processor executable instructions may be for receiving radio signal data by a computer from one or more sensors, calculating an estimate of radio propagation and signal strength using a first radio propagation model of a plurality of propagation models by the computer, and recalculating the estimate of radio propagation and signal strength using one or more radio propagation models of the plurality of radio propagation models by the computer.

### BRIEF DESCRIPTION OF THE DRAWINGS

FIG. 1 illustrates an example system 150 designed to calculate the radio signal field strength according to an embodiment;

FIG. 2 illustrates an example schematic illustration of a field strength prediction 200 for a hypothetical transmitter according to an embodiment;

FIG. 3 illustrates an example schematic illustration of the difference values 300 between a smooth-spline interpolation of measured points 201 and predicted values 200 according to an embodiment;

FIG. 4 illustrates an example schematic illustration of a corrected field strength prediction 400 according to an embodiment;

FIG. 5 illustrates an example schematic illustration 550 of a typical transmitter 500, its protected services contour 501 and the geographic extent of strong and usable signal strength 505;

FIG. 6 illustrates an example logical flowchart 600 for the iterative calculation of improved field strength estimation combining multiple predictive models;

FIG. 7 illustrates an example logical flowchart 700 for the correction of predicted field strength data by incorporating empirical sample data; and

FIG. 8 illustrates an example computer system 800 that may be configured to practice an exemplary embodiment; and

FIG. 9 illustrates another example logical flowchart 900 for the iterative calculation of improved field strength estimation combining multiple predictive models.

### DETAILED DESCRIPTION OF THE INVENTION

### Overview

One purpose of radio wave propagation models may be to predict the received signal strength at a given distance from a transmitter. Most large-scale propagation models typically predict the mean signal strength between transmitter-receiver pair for a given separation distance while short-scale propagation models, in contrast, are designed to study and predict a received signal's amplitude, phase or multipath interference for local geometries like urban environments or inside buildings.

U.S. Pat. No. 5,310,737 (1995) and U.S. Pat. No. 5,752,164 (1998) disclose a method of spectrum sharing that relies on detailed propagation modeling of the primary and secondary communication systems and spectrum occupancy measurements made by the secondary system. The propagation model's estimated values are verified with channel measurement values. However, as noted by the inventor, neither patent employs measured data as a corrective feedback to the propagation model estimates. The above cited patents are hereby incorporated by reference.

In 1965 and 1968, Rice and Longley proposed a point-to-point path-loss estimation model for frequencies from 40 MHz to 100,000 MHz. In 1973, the so-called Longley Rice method was translated into a computer algorithm. In 1988 the FCC, for example, designated the Longley Rice method as the standard algorithm it will use for propagation calculations in the FM and TV broadcast services. The Longley-Rice model is a computer implementation Of techniques described in National Bureau of Standards Technical Note 101, Transmission Loss Predictions for Tropospheric Communication Circuits, by P. L. Rice, A. G. Longley, K. A. Norton and A. P. Barsis, U.S. Department of Commerce, Revised Jan. 1, 1967. A publicly available computer implementation is maintained by the U.S. Department of Commerce, and methodologies for use are described in Federal Communications Commission OET Bulletin 69, Longley-Rice Methodology for Evaluating TV Coverage and Interference. The description, computer implementation and recommended methodology are hereby incorporated by reference.

In 1969 and 1975, Durkin developed a similar model and computer simulator incorporating diffraction from obstacles between the transmitter and receiver. In 1968 Okumura published a model that incorporates empirical environmental corrections, while in 1980 Hata proposed an empirical formulation for mobile services that made accommodations for a receiver with reduced height above ground. In 1988 Walfish and Bertoni introduced a model that considered the impact of rooftops and building height to predict signal strength at street level.

“Computer Prediction of Service Areas for VHF and UHF Land Mobile Radio Services,” by J. Durkin, IEEE Trans. on Vehicular Tech., Nov. 1977, “Field Strength and Its Variability in VHF and UHF Land-Mobile Radio Service,” by Y. Okumura et al, Rev. of the Electrical Comm. Lab. (Japan), September/October 1968 [Okumura model], “Empirical Formula for Propagation Loss in Land Mobile Radio Services,” by M. Hata, IEEE Trans. on Vehicular Tech., August 1980 [Hata model], “A theoretical model of UHF propagation in urban environments”, by J. Walfisch and H. Bertoni, 1988, IEEE Trans. Antennas and Propagation, Vol. 36, No. 12, which collectively describes the Durkin, Okumura, Hata, Walfish and Bertoni methods and algorithms are hereby incorporated by reference.

The Longley Rice and Durkin models provide similar propagation predictions for frequencies from 40 MHz to 100,000 MHz but do not accommodate environmental factors like the effects of buildings and foliage. Additionally, they make no consideration for multi-path signal effects. Other predictive models provide improved estimation for more narrowly described scenarios and frequency bands. For example, the Okumura and Hata models are both well suited for urban cellular and land mobile radio systems operating between 150 MHz and 1,500 MHz but encounter problems modeling radio signal strength in rural areas where propagation distances can extend beyond 1 km.

As a result, the current practice for the estimation of transmitter field strength is to select a single propagation model which is best suited for the service, frequencies and geography of interest.

An alternative embodiment may provide an accurate estimation of field strength values for large geographic areas, across very broad spectrum and for a variety of services and terrain types. This may be accomplished, for example, through a combination of multiple radio propagation models and a corrective feedback mechanism to ensure calculations match empirical. results.

Current methods for the calculation of transmitter field strength are stateless. The estimated field strength value is calculated in advance or on-demand and results may be stored to improve system performance. Further, current methods include no corrective feedback mechanism for adjusting the predictive algorithm to match real-world empirical results.

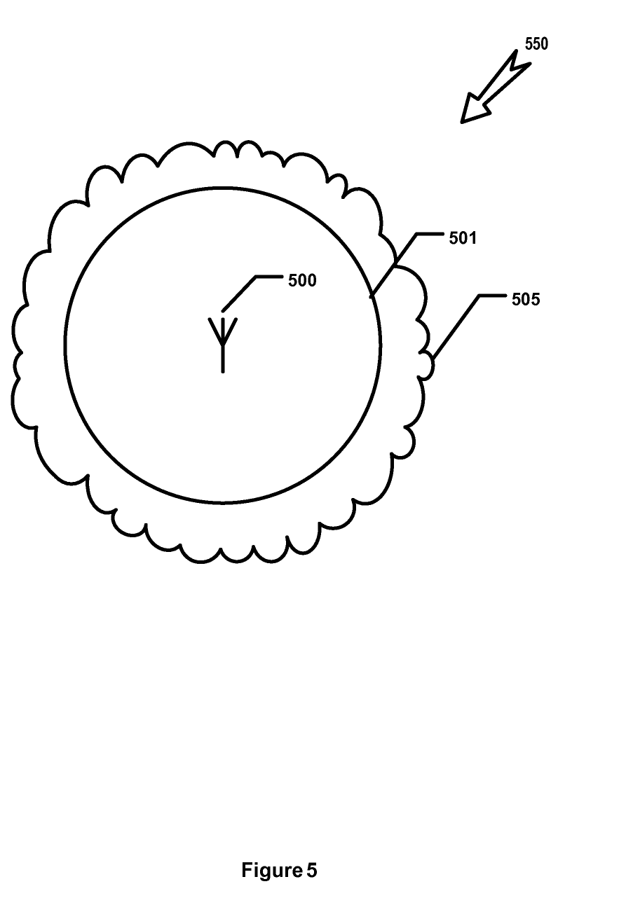

For example, in one embodiment of the invention, FIG. 5 illustrates an example schematic illustration of a typical transmitter 500. The protected services contour 501 depicts the geographic region that may be protected using current radio strength prediction methods. However, 505 depicts the extent of the usable signal strength from the transmitter 500.

An alternative embodiment, may incorporate a persistent database of field strength measurements and a feedback mechanism whereby predictive algorithms may be adjusted, whether by, for example, frequency, geography, season, time of day, type of terrain, transmitting power, antenna characteristics, or other factor, to more closely match empirical measurements. A more accurate predictive model may be produced that remains effective across large geographic areas of interest.

An embodiment of the invention may enable computer systems to more accurately predict the signal strength of a wireless radio service at an arbitrary distance from the transmitter and across a wide frequency spectrum. An embodiment of the invention may include a corrective feedback mechanism, allowing the predictive computer models to improve over time and as additional empirical measurements are incorporated into the model.

Example System

In one embodiment, a prediction of the field strength may be created for an arbitrary transmitter with arbitrary location, transmitting power, antenna height and frequency. The transmitted signal may be an arbitrary service on any detectable spectrum, whether licensed or unlicensed.

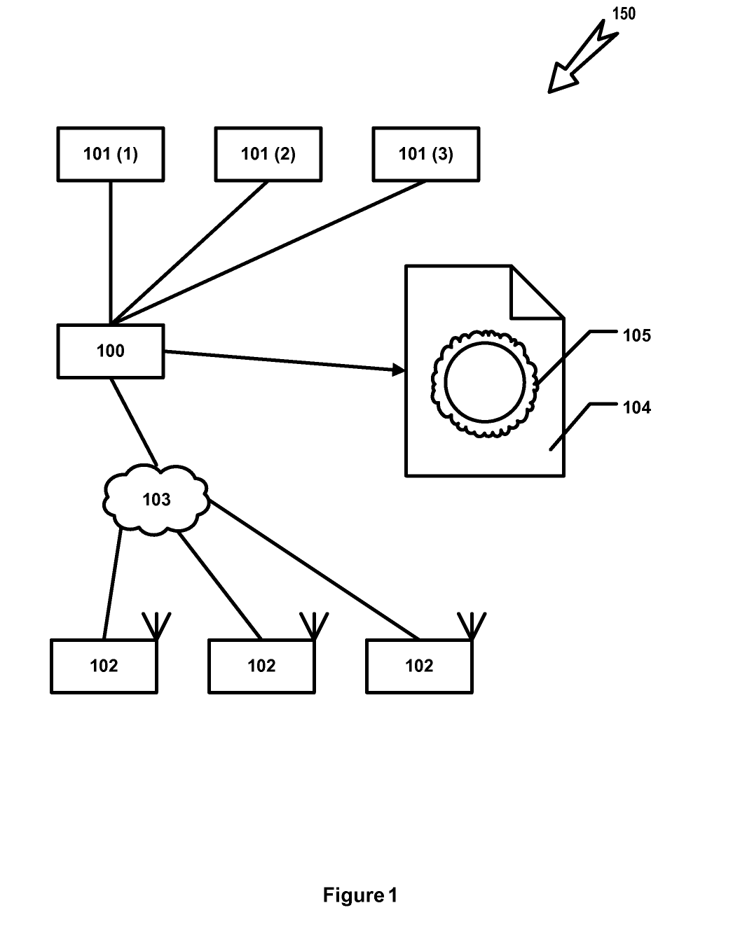

FIG. 1 illustrates an example system 150 designed to calculate the radio signal field strength according to an embodiment. In the embodiment illustrated by FIG. 1, a computer 100 may be employed to calculate the field strength contour for a transmitter of interest using, for example, a desired radio propagation model 101(1). The calculated result may be either a two or higher dimensional scalar array. Two dimension (2D) arrays may provide estimated field strength values for given latitude, longitude coordinate pairs and may be used to evaluate terrestrial wireless radio service availability. Three dimensional (3D) analyses may be required for aviation and space-based applications, while four dimensional (4D) analyses allows the analysis and tracking of spectrum variances over time. An embodiment of the invention may be applied to multi-dimensional scenarios without modification.

In an embodiment, computer 100 may calculate the field strength contour for the same transmitter 500 using one or more different propagation models 101 (2), 101 (3), etc. chosen automatically by the computer 100 and/or from a user configuration. Examples of the radio propagation models 101(1), 101(2), 101(3), etc. may include Free space path loss, Longley-Rice, Hata, Okumura, etc. The propagation models may be stored in one or more storage devices accessible by the computer 100. The recalculation process may be repeatedly iterated or run to accommodate any number of desired propagation models 101. As before, each calculation may produce a new scalar array 200. Each member of the set of calculated arrays may be called FSrunᵢ where the ‘i’ subscript indicates an index value ranging from 1 to the number of iterations or runs and may be used to identify an individual result. In other words, each run uses the same transmitter 500 data but may use a different propagation model 101.

The mathematical difference between the first and subsequently calculated field strength arrays may be calculated 300. The resulting new set of arrays containing difference information may be called FSdeltaᵢ, again where ‘i’ is the iteration value.

A normalized weighting factor FSweightᵢ may be assigned to each FSdelta array. The weighting factor may be a simple scalar constant or an array with values that may serve to amplify, attenuate or limit the influence each FSdelta array will have on the final field strength estimate. The weighting factor may be manually configured or automatically calculated. A weighting factor array may also limit the geographic influence of certain local, short-scale propagation models 101. For example, urban propagation model corrections may be limited to urban areas by weighting its values with a geographic masking field or by an equation whereby non-urban corrective values are forced to zero. In another embodiment, an average weighting factor may be applied across all propagation models 101.

In an embodiment, the original field strength array FSrun may be adjusted by adding a weighted average of the differences. The resulting calculated field strength data 104 may also be stored and archived, for example, as a computer file or database record in one or more storage devices accessible by the computer 100. The final field strength values may be called FSbest 105, which may be stored and archived, for example, as a computer file or database record, and may be mathematically described as:

$$FS best = FS {run}_{1} + {\sum }_{i = 2}^{n} FS {delta}_{i} * FS {weight}_{i}$$

where:

FSdeltaᵢ=FSrunᵢ−FSrunᵢ₋ₛ, i>1

and n=the number of models to be run

In one embodiment, FSbest may be the best-estimated field strength prediction.

In another embodiment, the FBbest 105 values that are archived may be used to calculate current estimated field strength. In another embodiment, the various propagation models 101 may be blended to provide an estimated field strength prediction.

The above described procedure may provide an improved general coverage model but may still deviate from reality as outdoor conditions may evolve; for example seasons pass and new construction may modify the terrain.

In an embodiment, empirical sampling may be incorporated as a corrective mechanism.

In an embodiment, computer system 100 and a plurality of sampling devices 102 (e.g., but not limited to, spectrum sensing apparatuses using matched filter detection, energy detection, and/or cyclostationary detection) may be interconnected via a digital communications network 103 (e.g., but not limited to, the Internet). Across the network 103, measured radio signal strength values from sampling devices 102 may be transmitted, along with other data, for example, their coordinates and time of measurement, to the computer 100. Computer 100 may map the received data to a set of field strength arrays according to each sample's characteristics.

In an embodiment, the samples may be further processed and filtered to identify information relevant to the spectrum of interest and set of transmitters under analysis. For example, a sampling device 102 may provide only the received power of single 6 MHz-wide Television channel at a single location or the sampling device 102 may provide a continuous power sweep of an entire frequency band provided by a spectrum analyzer along a specified geographic path.

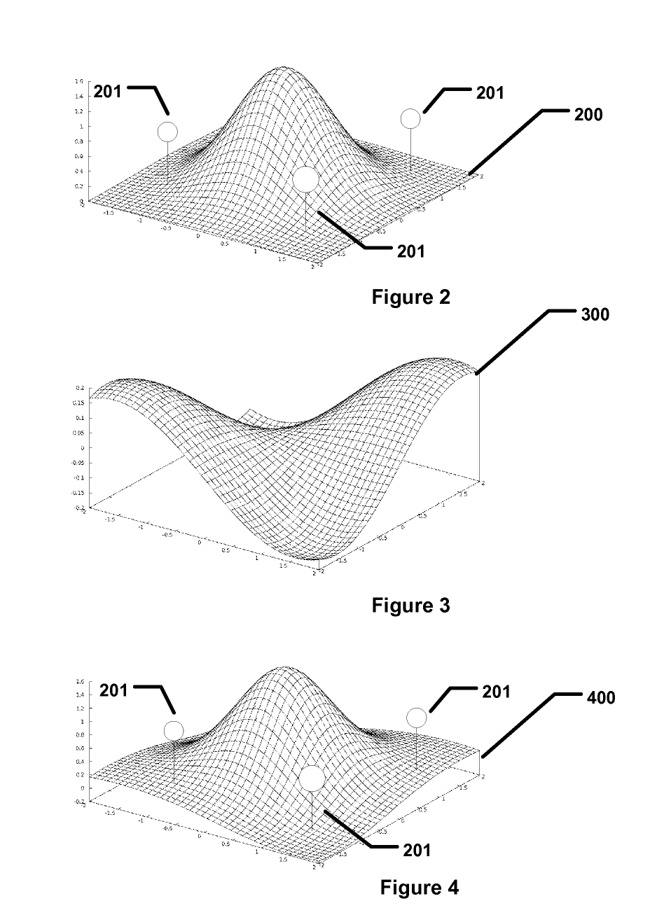

In an embodiment, FIG. 2 illustrates an example schematic illustration of field strength prediction 200 for a hypothetical transmitter according to an embodiment. A plurality of empirical measurements corresponding to specific geographic locations 201 may be received. Geographic locations 201 (presented in FIG. 2 as a circle with a line, where the non-circle, end of the line, identifies a data point) represent discrete field strength measurement points between which an interpolation of differences from theory may be made.

FIG. 3 illustrates an example schematic illustration of the difference values 300 between a smooth-spline interpolation of measured points 201 and predicted values 200 according to an embodiment. With the plurality of empirical measurements corresponding to specific geographic locations 201, a new hypothetical field strength topology may be interpolated and the differences between this interpolated array and the original may be calculated and shown as 300.

FIG. 4 illustrates an example schematic illustration of the corrected field strength prediction 400 according to an embodiment. Three-dimensional graph 400 may be the resultant field strength estimate calculated by incorporating corrective values and matching empirical measurements. In the embodiment displayed in FIG. 4, the original predictive model 200 may then be adjusted such that the new predicted values 400 may more closely match the empirical measurements 201.

In another embodiment, the computer 100 may also attempt to match received samples (e.g., but not limited to, empirical samples or arbitrary samples) to a known transmitter by matching the sensed criterion with predicted values. If no known transmitter is identified, the sample may indicate the presence of an unauthorized, unknown or unlicensed radiator, and the computer 100 may then cause an exception report to be issued, ignore the sample, or take further actions to attempt to identify the transmitter. If the samples match a known transmitter, the samples may be used to adjust and correct the estimated radio propagation and signal strength for a known transmitter (where a transmitter may correspond to, e.g., an identified frequency, location, and time). The sample data for identified frequencies, locations, and times may be interpolated and/or extrapolated to create an estimated field strength topology.

In one embodiment, the computer 100 may provide persistent, stateful maintenance and continuing correction of calculated field strength data to match empirically measured results. For example, data from the one or more sampling devices 102 may be continuously monitored, or monitored at set intervals (e.g., every second, every minute, every hour, every day, etc.). With more constant monitoring, temporal variance in the spectrum may be detected. For example, different frequency profiles may be discovered during different times of the day and/or during different seasons, etc. These temporal patterns may then be used to enhance the estimated field signal strength.

Exemplary Processing

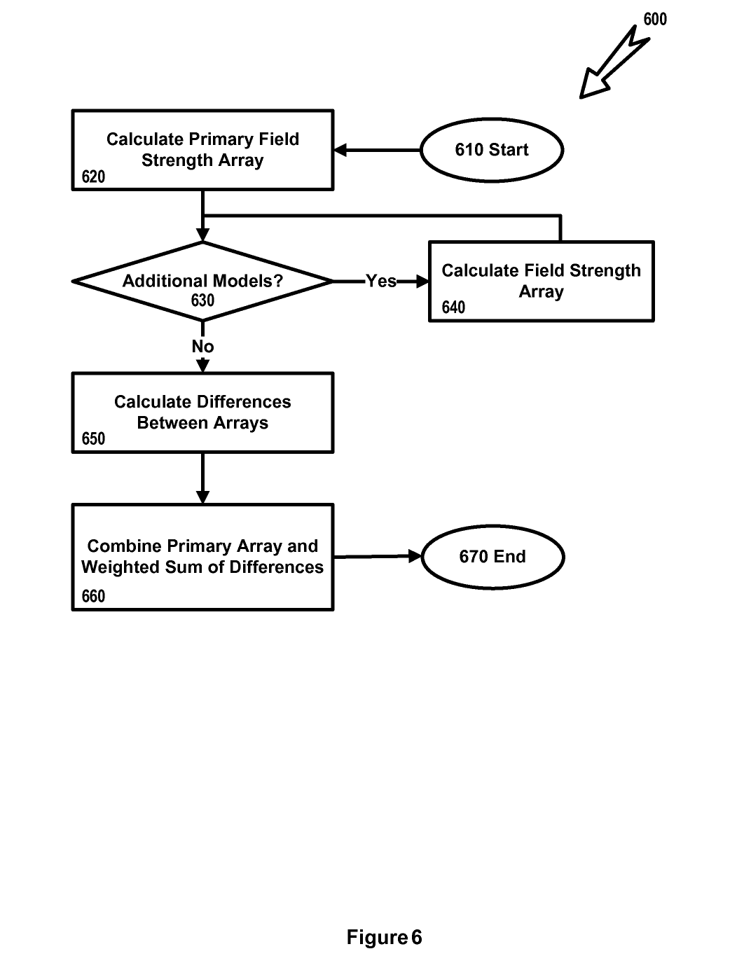

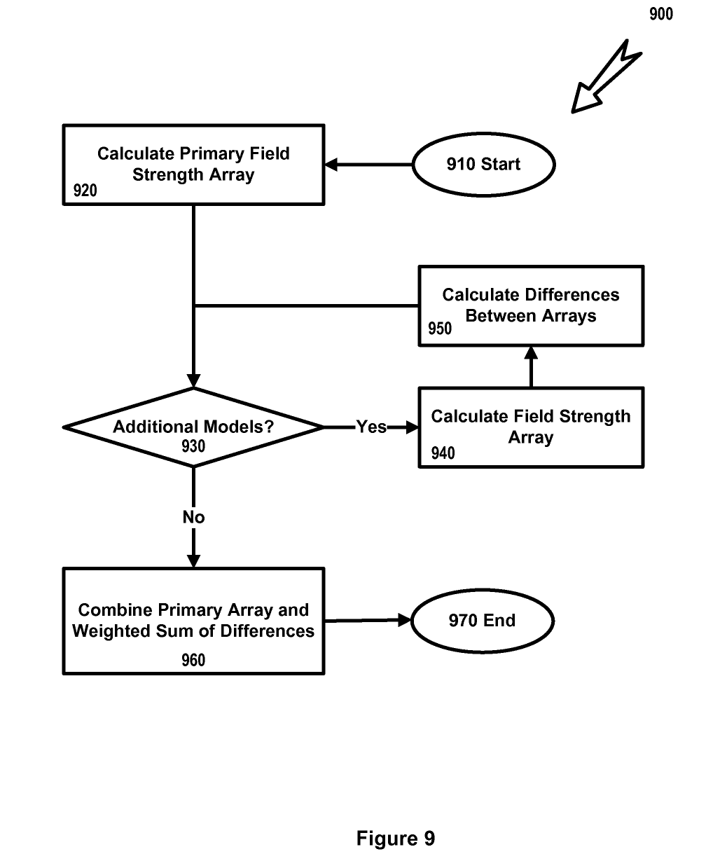

FIG. 6 illustrates an example logical flowchart 600 for the iterative calculation of improved field strength estimation combining multiple predictive models. Flowchart 600 describes processing performed by hardware in an exemplary embodiment. Flowchart 600 begins at Start 610 and may flow directly to 620. In 620, using a radio propagation model e.g., 101(1), the primary field strength array may be calculated. From 620, flow may move to 630. In 630, additional radio propagation models may be chosen either through direct user input, preconfigured selection, or automatically based on external factors such as computer analysis of frequency, terrain, season, service of interest, distance of interest, etc. As each radio propagation model is chosen in 630, flow may then move to 640, where the field strength array may be calculated using the radio propagation model selected in 630. In 630, the result of the calculation may be stored. From 640, flow may then move back to 630, where any additional radio propagation models may be selected and calculated in 640. Once all radio propagation models have been selected in 630 and the corresponding field strength arrays calculated in 640, flow may move to 650. In 650, the differences between the arrays may be calculated. Alternatively, differences may also be calculated after each model is run as shown in FIG. 9. From 650, flow then moves to 660, where the primary field strength array (calculated in 620) is combined with, for example, the weighted sum of differences (where the differences between the arrays may have been calculated in 650) and a final primary field strength array may be created. From 660, flow may stop at End 670.

FIG. 9 illustrates another example logical flowchart 900 for the iterative calculation of improved field strength estimation combining multiple predictive models. Flowchart 900 describes processing performed by hardware in an exemplary embodiment. Flowchart 900 begins at Start 910 and may flow directly to 920. In 920, using a radio propagation model e.g., 101(1), the primary field strength array may be calculated. From 920, flow may move to 930. In 930, additional radio propagation models may be chosen either through direct user input, preconfigured selection, or automatically based on external factors such as computer analysis of frequency, terrain, season, service of interest, distance of interest, etc. As each radio propagation model is chosen in 930, flow may then move to 940, where the field strength array may be calculated using the radio propagation model selected in 930. From 940, flow may then move to 950, where a difference array may be calculated and stored. From 940, flow may move back to 930 and any additional radio propagation models may be selected and flow may again move to 940. Once all radio propagation models have been selected in 930 flow may then move to 960.

In 960, the primary model from 920 is combined with all the difference models (plus their weights) from 960 and a result is achieved. From 960, flow may stop at End 970.

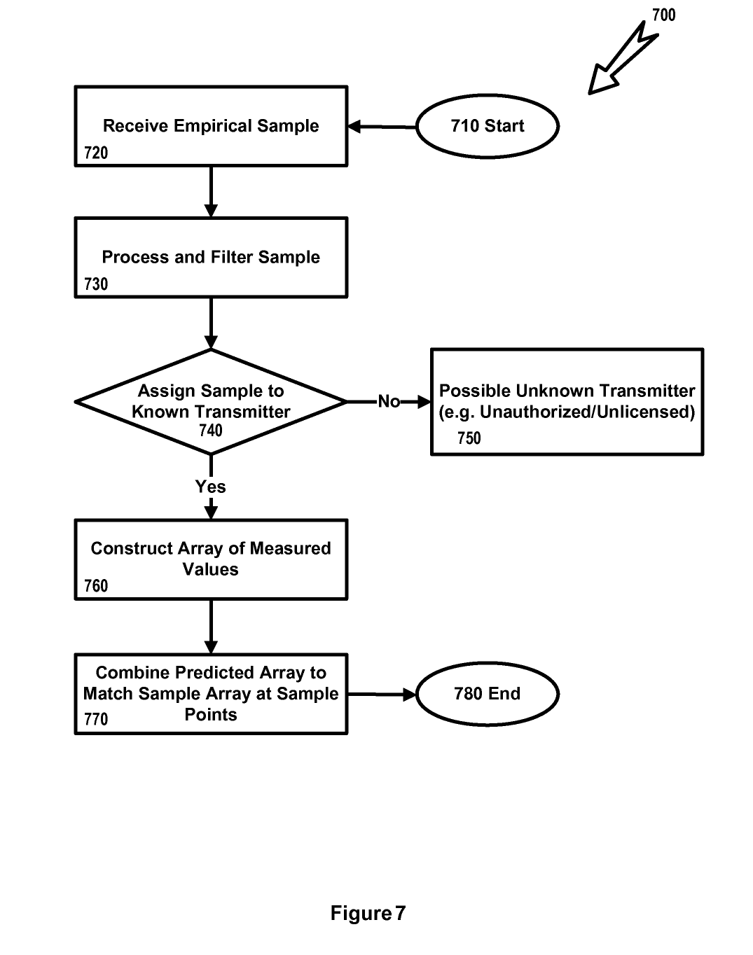

FIG. 7 illustrates an example logical flow chart 700 for the correction of predicted field strength data by incorporating empirical sample data. Flowchart 700 describes processing performed by hardware in an exemplary embodiment. Flowchart 700 begins at Start 710 and may flow directly to 720. In 720, one or more empirical samples may be received from one or more sampling devices 102. From 720, flow may move to 730, where the empirical samples may be processed and filtered to identify information relevant to the spectrum of interested set of transmitters under analysis. From 730, the flow may move to 740, where each of the one or more processed and filtered empirical samples may be tested against a known collection of transmitters. In 740, if the processed and filtered empirical sample does not match a transmitter in the list of transmitters, then flow may move to 750. In 750, the processed and filtered empirical sample may be unknown and the sample may be discarded from further analysis. In 740, if the processed and filtered empirical sample does match a known transmitter, then flow may move to 760. In 760, the collection of known, processed, and filtered empirical samples 201 may be used to create a sample array of measured values. Each empirical sample may be assigned to an empirical sample point, e.g., points 201, corresponding to a predicted point within the calculated array 200. From 760, flow may move to 770, where a predicted field strength array (based on previous data) e.g., strength prediction 200, may be combined to match the measured values array, from 760, at empirical sample points, e.g., points 201 to create an improved radio signal field strength array e.g., corrective field strength prediction 400. The resulting calculated field strength data 104 may be adjusted based on the newly acquired data and calculations. From 770, flow may move to End 780.

In an embodiment, the computer 100 may thereafter use or forward the resulting calculated field strength data 104 to another computer for use in various applications that require accurate spectrum prediction and modeling, such as, for example, interference analysis for new transmitter licensing permits, radio spectrum occupancy estimates, wireless service availability modeling, and/or as input to dynamic spectrum sharing applications.

Exemplary Computing Architecture Example System

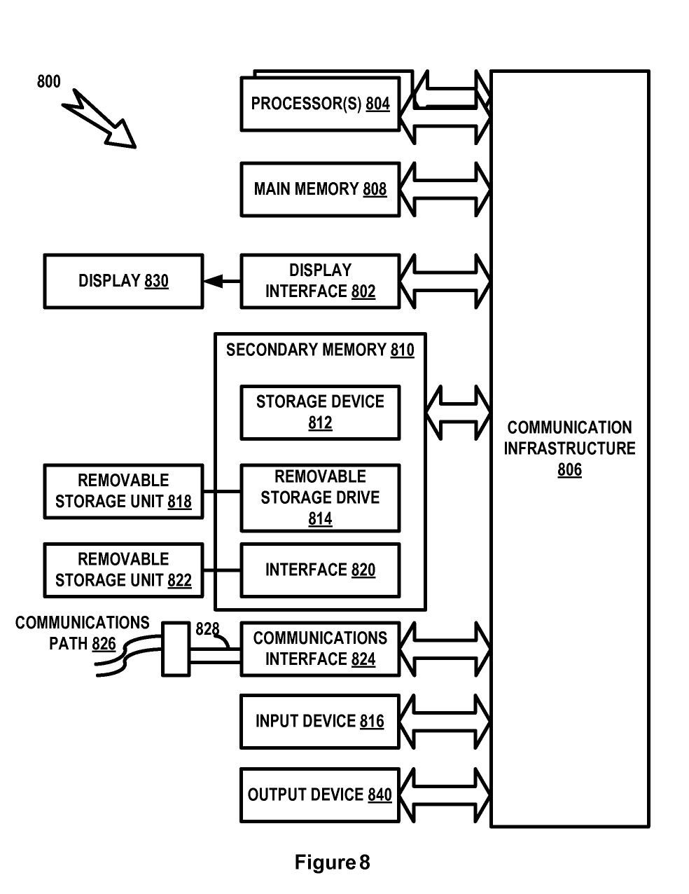

FIG. 8 depicts an exemplary embodiment of a computer system 800 that may be used in association with, in connection with, and/or in place of, e.g., but not limited to, any of the foregoing components and/or systems. The computer 100, sensors 102, and/or transmitter 500 may be implemented with one or more computer systems 800.

The present embodiments (or any part(s) or function(s) thereof) may be implemented using hardware, software, firmware, or a combination thereof and may be implemented in one or more computer systems or other processing systems. In fact, in one exemplary embodiment, the invention may be directed toward one or more computer systems capable of carrying out the functionality described herein. An example of a computer system 800 is shown in FIG. 8, depicting an exemplary embodiment of a block diagram of an exemplary computer system useful for implementing the present invention. Specifically, FIG. 8 illustrates an example computer system 800, which in an exemplary embodiment may be, e.g., (but not limited to) a personal computer (PC) system running an operating system such as, e.g., (but not limited to) WINDOWS MOBILE™ for POCKET PC, or MICROSOFT® WINDOWS® NT/98/2000/XP/CE/7NISTA, etc. available from MICROSOFT® Corporation of Redmond, Wash., U.S.A., SOLARIS® from SUN® Microsystems of Santa Clara, Calif., U.S.A., OS/2 from IBM® Corporation of Armonk, N.Y., U.S.A., Mac/OS from APPLE® Corporation of Cupertino, Calif., U.S.A., etc., or any of various versions of UNIX® (a trademark of the Open Group of San Francisco, Calif., USA) including, e.g., LINUX®, HPUX®, IBM AIX®, and SCO/UNIX®, etc. However, the invention may not be limited to these platforms. Instead, the invention may be implemented on any appropriate computer system running any appropriate operating system. In one exemplary embodiment, the present invention may be implemented on a computer system operating as discussed herein. Other components of the invention, such as, e.g., (but not limited to) a computing device, a communications device, a telephone, a personal digital assistant (PDA), a personal computer (PC), a handheld PC, client workstations, thin clients, thick clients, proxy servers, network communication servers, remote access devices, client computers, server computers, routers, web servers, data, media, audio, video, telephony or streaming technology servers, etc., may also be implemented using a computer such as that shown in FIG. 8.

The computer system 800 may include one or more processors, such as, e.g., but not limited to, processor(s) 804. The processor(s) 804 may be connected to a communication infrastructure 806 (e.g., but not limited to, a communications bus, cross-over bar, or network, etc.). Various exemplary software embodiments may be described in terms of this exemplary computer system. After reading this description, it will become apparent to a person skilled in the relevant art(s) how to implement the invention using other computer systems and/or architectures.

Computer system 800 may include a display interface 802 that may forward, e.g., but not limited to, graphics, text, and other data, etc., from the communication infrastructure 806 (or from a frame buffer, etc., not shown) for display on the display unit 830.

The computer system 800 may also include, e.g., but may not be limited to, a main memory 808, random access memory (RAM), and a secondary memory 810, etc. The secondary memory 810 may include, for example, (but may not be limited to) a hard disk drive 812 and/or a removable storage drive 814, representing a floppy diskette drive, a magnetic tape drive, an optical disk drive, a magneto-optical disk drive, a compact disk drive CD-ROM, a digital versatile disk (DVD), a write once read many (WORM) device, a flash memory device, etc. The removable storage drive 814 may, e.g., but not limited to, read from and/or write to a removable storage unit 818 in a well known manner. Removable storage unit 818, also called a program storage device or a computer program product, may represent, e.g., but not limited to, a floppy disk, a magnetic tape, an optical disk, a magneto-optical disk, a compact disk, a flash memory device, etc. which may be read from and written to by removable storage drive 814. As will be appreciated, the removable storage unit 818 may include a computer usable storage medium having stored therein computer software and/or data.

In alternative exemplary embodiments, secondary memory 810 may include other similar devices for allowing computer programs or other instructions to be loaded into computer system 800. Such devices may include, for example, a removable storage unit 822 and an interface 820. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 822 and interfaces 820, which may allow software and data to be transferred from the removable storage unit 822 to computer system 800.

Computer 800 may also include an input device 816 such as, e.g., (but not limited to) a mouse or other pointing device such as a digitizer, a keyboard or other data entry device (none of which are labeled), and/or a touchscreen integrated with display 830, etc.

Computer 800 may also include output devices 840, such as, e.g., (but not limited to) display 830, and display interface 802. Computer 800 may include input/output (I/O) devices such as, e.g., (but not limited to) communications interface 824, cable 828 and communications path 826, etc. These devices may include, e.g., but not limited to, a network interface card, and modems (neither are labeled). Communications interface 824 may allow software and data to be transferred between computer system 800 and external devices. Examples of communications interface 824 may include, e.g., but may not be limited to, a modem, a network interface (such as, e.g., an Ethernet card), a communications port, a Personal Computer Memory Card International Association (PCMCIA) slot and card, a transceiver, a global positioning system receiver, etc. Software and data transferred via communications interface 824 may be in the form of signals 828 which may be electronic, electromagnetic, optical or other signals capable of being received by communications interface 824. These signals 828 may be provided to communications interface 824 via, e.g., but not limited to, a communications path 826 (e.g., but not limited to, a channel). This channel 826 may carry signals 828, which may include, e.g., but not limited to, propagated signals, and may be implemented using, e.g., but not limited to, wire or cable, fiber optics, a telephone line, a cellular link, an radio frequency (RF) link and other communications channels, etc.

In this dobument, the terms “computer program medium” and “computer readable medium” may be used to generally refer to media such as, e.g., but not limited to removable storage drive 814, a hard disk installed in hard disk drive and/or other storage device 812, etc. These computer program products may provide software to computer system 800. The invention may be directed to such computer program products.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses and/or devices for performing the operations herein. An apparatus may be specially constructed for the desired purposes, or it may comprise a general purpose device selectively activated or reconfigured by a program stored in the device.

Embodiments of the invention may be implemented in one or a combination of hardware, firmware, and software. Embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, an exemplary machine-readable storage medium may include, e.g., but not limited to, read only memory (ROM); random access memory (RAM); magnetic disk storage media; optical storage media; magneto-optical storage media; flash memory devices.

Computer programs (also called computer control logic), may include object oriented computer programs, and may be stored in main memory 808 and/or the secondary memory 810 and/or removable storage drive 814, removable storage unit 818, removable storage unit 822, also called computer program products. Such computer programs, when executed, may enable the computer system 800 to perform the features of the present invention as discussed herein. In particular, the computer programs, when executed, may enable the processor or processors 804 to provide a method to control and/or manage operation of a positioning effect detection device according to an exemplary embodiment of the present invention. Accordingly, such computer programs may represent controllers of the computer system 800.

In another exemplary embodiment, the invention may be directed to a computer program product comprising a computer readable medium having control logic (computer software) stored therein. The control logic, when executed by the processor 804, may cause the processor 804 to perform the functions of the invention as described herein. In another exemplary embodiment where the invention may be implemented using software, the software may be stored in a computer program product and loaded into computer system 800 using, e.g., but not limited to, removable storage drive 814, hard drive 812 or communications interface 824, etc. The control logic (software), when executed by the processor 804, may cause the processor 804 to perform the functions of the invention as described herein. The computer software may run as a standalone software application program running atop an operating system, or may be integrated into the operating system.

In yet another embodiment, the invention may be implemented primarily in hardware using, for example, but not limited to, hardware components such as application specific integrated circuits (ASICs), or one or more state machines, etc. Implementation of the hardware state machine so as to perform the functions described herein will be apparent to persons skilled in the relevant art(s).

In another exemplary embodiment, the invention may be implemented primarily in firmware.

In yet another exemplary embodiment, the invention may be implemented using a combination of any of, e.g., but not limited to, hardware, firmware, and software, etc.

The exemplary embodiment of the present invention makes reference to, e.g., but not limited to, communications links, wired, and/or wireless networks. Wired networks may include any of a wide variety of well known means for coupling voice and data communications devices together. A brief discussion of various exemplary wireless network technologies that may be used to implement the embodiments of the present invention now are discussed. The examples are non-limiting. Exemplary wireless network types may include, e.g., but not limited to, code division multiple access (CDMA), spread spectrum wireless, orthogonal frequency division multiplexing (OFDM), 1G, 2G, 3G wireless, Bluetooth, Infrared Data Association (IrDA), shared wireless access protocol (SWAP), “wireless fidelity” (Wi-Fi), WIMAX, and other IEEE standard 802.11-compliant wireless local area network (LAN), 802.16-compliant wide area network (WAN), and ultrawideband (UWB) networks, etc.

IrDA is a standard method for devices to communicate using infrared light pulses, as promulgated by the Infrared Data Association from which the standard gets its name. Since IrDA devices use infrared light, they may depend on being in line of sight with each other.

The exemplary embodiments of the present invention may make reference to WLANs. Examples of a WLAN may include a shared wireless access protocol (SWAP) developed by Home radio frequency (HomeRF), and wireless fidelity (Wi-Fi), a derivative of IEEE 802.11, advocated by the wireless Ethernet compatibility alliance (WECA). The IEEE 802.11 wireless LAN standard refers to various technologies that adhere to one or more of various wireless LAN standards. An IEEE 802.11 compliant wireless LAN may comply with any of one or more of the various IEEE 802.11 wireless LAN standards including, e.g., but not limited to, wireless LANs compliant with IEEE std. 802.11a, b, d, g, or n, such as, e.g., but not limited to, IEEE std. 802.11a, b, d, g and n (including, e.g., but not limited to IEEE 802.11 g-2003, etc.), etc.

Unless specifically stated otherwise, as apparent from the following discussions, it may be appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

According to an exemplary embodiment, exemplary methods set forth herein may be performed by an exemplary one or more computer processor(s) adapted to process program logic, which may be embodied on an exemplary computer accessible storage medium, which when such program logic is executed on the exemplary one or more processor(s) may perform such exemplary steps as set forth in the exemplary methods.

While various embodiments of the present invention have been described above, it should be understood that they have been presented by way of example only, and not limitation. Thus, the breadth and scope of the present invention should not be limited by any of the above-described illustrative embodiments, but should instead be defined only in accordance with the following claims and their equivalents

1. A computer-implemented method to calculate radio propagation and estimate radio signal strength comprising:
calculating a first estimate of radio propagation and signal strength by a computer having at least one processor using a first radio propagation model;
calculating a second estimate of radio propagation and signal strength by the computer using a second radio propagation model; and
creating a corrective estimate of radio propagation and signal strength by the computer using the first estimate and the second estimate.

2. The method of claim 1, further comprising:
calculating iterative estimates of radio propagation and signal strength by the computer using one or more radio propagation models;
creating iterative corrective estimates of radio propagation and signal strength by the computer using the corrective estimate of radio propagation and signal strength and the iterative estimates of radio propagation and signal strength.

3. The method of claim 2, wherein the first radio propagation model and each propagation model of the one or more of radio propagation models are selected based on at least one of computer analysis of frequency, terrain, season or service of interest.

4. The method of claim 1, wherein a portion of the second radio propagation model is masked when the second estimate is calculated.

5. The method of claim 1, further comprising:
receiving sample data by the computer from one or more sensors; and
modifying the corrective estimate of radio propagation and signal strength by the computer by incorporating the sample data.

6. The method of claim 5, wherein sample data comprises at least one of:
empirical sample data for identified frequencies, locations, and times;
arbitrary sample data;
unknown transmitter sample data; or
unlicensed transmitter sample data.

7. The method of claim 6, further comprising:
creating an estimate field strength topology using empirical sample data for identified frequencies, locations, and times, using at least one of interpolation or extrapolation of the empirical sample data.

8. The method of claim 5, further comprising:
updating the corrective estimate of radio propagation and signal strength by a computer by periodically recalculating the corrective estimate of radio propagation and signal strength based on the sample data.

9. The method of claim 5, further comprising:
correlating and matching the received sample data to a known transmitter by the computer by comparing the received sample data to predicted values for the known transmitter.

10. The method of claim 9, wherein unauthorized transmitters are recognized or inferred by the absence of a matching known transmitter.

11. A system comprising:
a computer having at least one processor and at least one storage device, the computer configured to:
calculate an estimate of radio propagation and signal strength using a first radio propagation model and the at least one processor;
recalculate the estimate of radio propagation and signal strength using one or more additional radio propagation models and the at least one processor; and
store the recalculated estimate of radio propagation and signal strength in the at least one storage device.

12. The system of claim 11, wherein the first radio propagation model and each propagation model of the additional radio propagation models are selected based on at least one of computer analysis of frequency, terrain, season, time, or service of interest.

13. The system of claim 11, wherein the computer is further configured to receive sample data from one or more sampling devices and update the estimate of radio propagation and signal strength by incorporating the received sample data.

14. The system of claim 13, wherein sample data comprises at least one of:
empirical sample data for identified frequencies, locations, and times;
arbitrary sample data;
unknown transmitter sample data; or
unlicensed transmitter sample data.

15. The system of claim 14, wherein the computer is further configured to analyze sample characteristics of received arbitrary sample data; and correlate and match the received arbitrary sample data to predicted values of a known transmitter.

16. The system of claim 15, wherein unauthorized transmitters are recognized or inferred by the absence of the matching known transmitter.

17. The system of claim 13, wherein the computer is further configured to create an estimate field strength topology using empirical sample data for identified frequencies, locations, and times, using at least one of interpolation or extrapolation of the empirical sample data.

18. The system of claim 11, wherein the computer is further configured to:
update the corrective estimate of radio propagation and signal strength by a computer by periodically recalculating the corrective estimate of radio propagation and signal strength based on the sample data.

19. A computer-readable medium comprising processor executable instructions for:
receiving radio signal data by a computer from one or more sensors;
calculating an estimate of radio propagation and signal strength using a first radio propagation model of a plurality of propagation models by the computer; and
recalculating the estimate of radio propagation and signal strength using one or more radio propagation models of the plurality of radio propagation models by the computer.

20. The computer-readable medium of claim 19, wherein the first radio propagation model and each propagation model from the plurality of radio propagation models are selected based on at least one of computer analysis of frequency, terrain, season, time, or service of interest.
